(19) United States
(12) Patent Application Publication
(10) Pub. No.: US 2015/0042605 A1
(43) Pub. Date: Feb. 12, 2015

(54) TOUCH SENSOR MODULE

(71) Applicant: SAMSUNG ELECTRO-MECHANICS CO., LTD., Suwon-Si (KR)

(72) Inventor: Wan Jae Lee, Suwon-Si (KR)

(73) Assignee: SAMSUNG ELECTRO-MECHANICS CO., LTD., Suwon-Si (KR)

(21) Appl. No.: 14/250,239

(22) Filed: Apr. 10, 2014

(30) Foreign Application Priority Data
Aug. 9, 2013 (KR) 10-2013-0094965

(51) Int. Cl. G06F 3/046

(52) U.S. Cl. CPC G06F 3/046
USPC 345/174

(57) ABSTRACT

Disclosed herein is a touch sensor module including: a base substrate having a plurality of electrode pads formed on one surface thereof; a flexible cable including terminal parts formed so as to correspond to the plurality of electrode pads and electrically connected to the plurality of electrode pads to transfer a signal to the outside and including penetration parts disposed between the terminal parts; and a conductive layer including conductive balls disposed between the electrode pads and the terminal parts and electrically connecting the electrode pads and the terminal parts to each other.

### CROSS REFERENCE TO RELATED APPLICATION

This application claims the benefit of Korean Patent Application No. 10-2013-0094965, filed on Aug. 9, 2013, entitled “Touch Sensor Module”, which is hereby incorporated by reference in its entirety into this application.

### BACKGROUND OF THE INVENTION

1. Technical Field

The present invention relates to a touch sensor module.

2. Description of the Related Art

In accordance with the growth of computers using a digital technology, devices assisting computers have also been developed, and personal computers, portable transmitters, other personal information processors, and the like, execute processing of text and graphics using various input devices such as a keyboard and a mouse.

In accordance with the rapid advancement of an information-oriented society, the use of computers has gradually been widened. However, it is difficult to efficiently operate products using only a keyboard and a mouse currently serving as an input device.

Therefore, the necessity for a device that is simple, has a less malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like. This touch panel is mounted on a display surface of a display such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the display.

In addition, the touch panel is classified into a resistive type touch panel, a capacitive type touch panel, an electromagnetic type touch panel, a surface acoustic wave (SAW) type touch panel, and an infrared type touch panel.

These various types of touch panels are adapted for electronic products in consideration of a signal amplification problem, a resolution difference, a level of difficulty to of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

As a specific example of a touch panel according to the prior art, there may be a touch panel disclosed in Korean Patent Laid-Opened Publication No. 10-2011-0107590.

Describing a structure of the touch panel disclosed in a description of the prior art in a content of Korean Patent Laid-Opened Publication No. 10-2011-0107590, the touch panel is configured to include a substrate, electrodes formed on the substrate, electrode wirings extended from the electrodes and gathered on one end of the substrate, and a controller connected to the electrode wirings through a flexible printed circuit board (hereinafter, referred to as a ‘flexible cable’).

Here, the flexible cable serves to transfer signals generated in the electrode to the controlling unit through the electrode wirings. In addition, the flexible cable electrically contacts and is connected to the electrode wiring in order to transfer a signal. However, a connection defect between the flexible cable and the electrode wiring is frequently generated, and reliability of a product is decreased due to the frequent connection defect.

### PRIOR ART DOCUMENT

### Patent Document

(Patent Document 1) KR10-2011-0107590 A

### SUMMARY OF THE INVENTION

The present invention has been made in an effort to provide a touch sensor module capable of improving reliability of a product by increasing coupling force between a touch sensor and a flexible cable.

According to a first preferred embodiment of the present invention, there is provided a touch sensor module including: a base substrate having a plurality of electrode pads formed on one surface thereof; a flexible cable including terminal parts formed so as to correspond to the plurality of electrode pads and electrically connected to the plurality of electrode pads to transfer a signal to the outside and including penetration parts disposed between the terminal parts; and a conductive layer including conductive balls disposed between the electrode pads and the terminal parts and electrically connecting the electrode pads and the terminal parts to each other.

The penetration part may have a diameter larger than those of the conductive balls so that the conductive balls move to an opposite surface of the terminal part.

A plurality of penetration parts may be formed along an outer peripheral surface of the terminal part.

The penetration part may be formed in a semi-hole form at a distal end of the flexible cable so that the conductive balls move to an opposite surface of the terminal part to increase coupling force.

The conductive layer may be made of an anisotropic conductive film (ACF) or an anisotropic conductive adhesive (ACA).

According to a second preferred embodiment of the present invention, there is provided a touch sensor module including: a base substrate having a plurality of electrode pads formed on one surface thereof and penetration parts formed between the electrode pads; a flexible cable including terminal parts formed so as to correspond to the plurality of electrode pads and electrically connected to the plurality of electrode pads to transfer a signal; and a conductive layer including conductive balls disposed between the electrode pads and the terminal parts and electrically connecting the electrode pads and the terminal parts to each other.

The penetration part may be formed so that the conductive balls move to an opposite surface of the electrode pad or are positioned in the base substrate.

A plurality of penetration parts may be formed along an outer peripheral surface of the electrode pad.

The penetration part may be formed at a distal end of the base substrate so that the conductive balls move to an opposite surface of the electrode pad to increase coupling force.

The conductive layer may be made of an ACF or an ACA.

According to a third preferred embodiment of the present invention, there is provided a touch sensor module including: a base substrate having a plurality of electrode pads formed on one surface thereof and a first penetration part formed between the electrode pads; a flexible cable including terminal parts formed so as to correspond to the plurality of electrode pads and electrically connected to the plurality of electrode pads to transfer a signal and a second penetration part disposed between the terminal parts; and a conductive layer including conductive balls disposed between the electrode pads and the terminal parts and electrically connecting the electrode pads and the terminal parts to each other.

The first penetration part may have a diameter larger than those of the conductive balls so that the conductive balls are pressed, such that they move to an opposite surface of the electrode pad or some of the conductive balls are inserted into the first penetration part, and the second penetration part may have a diameter larger than those of the conductive balls so that the conductive balls are pressed, such that they move to an opposite surface of the terminal part or some of the conductive balls are inserted into the second penetration part.

The first penetration part may be formed at a distal end of the base substrate so that the conductive balls move to an opposite surface of the electrode pad to increase coupling force.

The second penetration part may be formed at a distal end of the base substrate so that the conductive balls move to an opposite surface of the terminal part to increase coupling force.

The first and second penetration parts may be formed at distal ends of the base substrate and the flexible cable, respectively, so that the conductive balls move to an to opposite surface of the electrode pad and the terminal part to increase coupling force.

The conductive layer may be made of an ACF or an ACA.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of assembly between a touch sensor and a flexible cable according to a first preferred embodiment of the present invention;

FIG. 2 is a view showing a moving state of conductive balls of FIG. 1;

FIG. 3 is a partial perspective view of FIG. 1;

FIG. 4 is a view showing a first modified example for assembly between the touch sensor and the flexible cable according to the first preferred embodiment of the present invention;

FIG. 5 is a partial perspective view of FIG. 4;

FIG. 6 is a view showing a second modified example for assembly between the touch sensor and the flexible cable according to the first preferred embodiment of the present invention;

FIG. 7 is a partial perspective view of FIG. 6;

FIG. 8 is a front view of a flexible cable according to a second preferred embodiment of the present invention;

FIG. 9 is a cross-sectional view of assembly between a touch sensor and a flexible cable according to the second preferred embodiment of the present invention;

FIG. 10 is a view showing a third modified example for assembly between the touch sensor and the flexible cable according to the second preferred embodiment of the present invention;

FIG. 11 is a view showing a fourth modified example for assembly between the to touch sensor and the flexible cable according to the second preferred embodiment of the present invention; and

FIG. 12 is a view showing a fifth modified example for assembly between the touch sensor and the flexible cable according to the second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

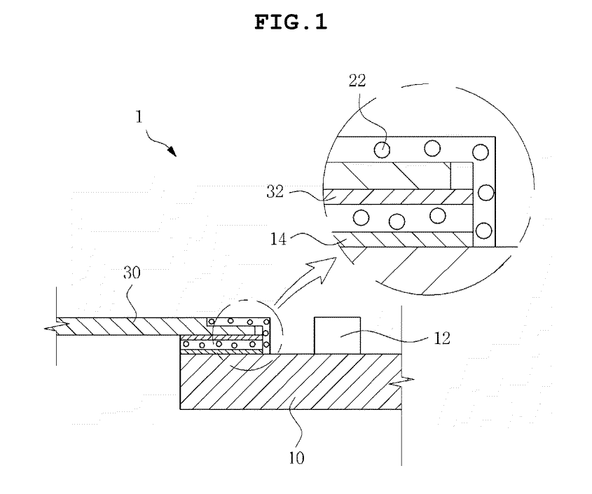

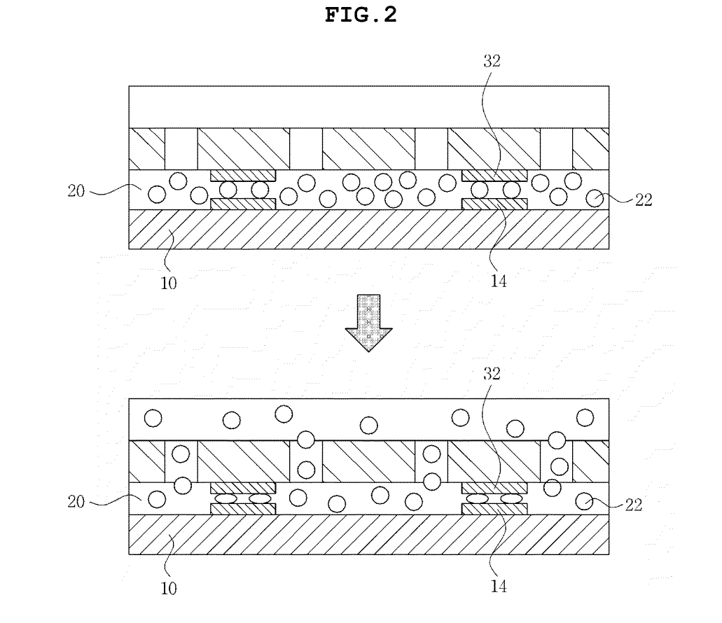

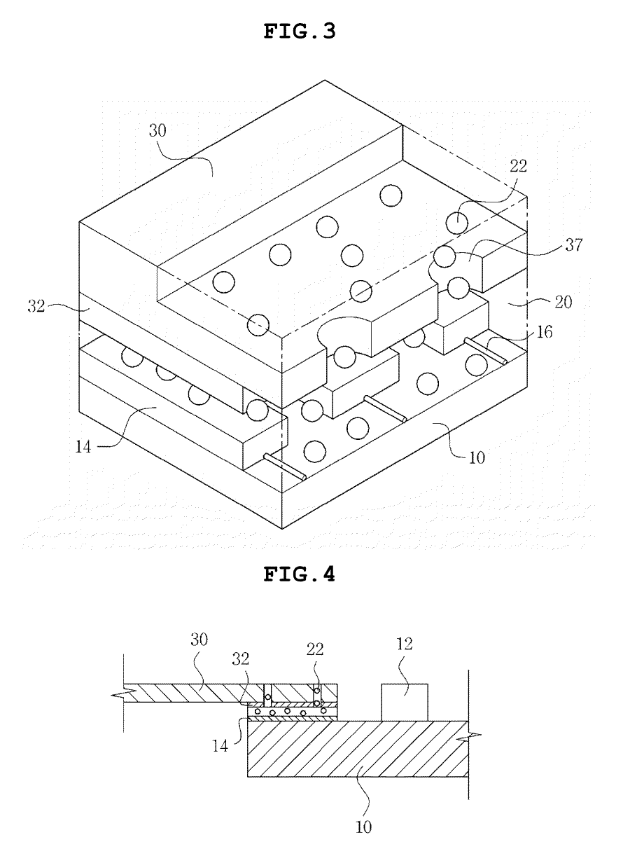

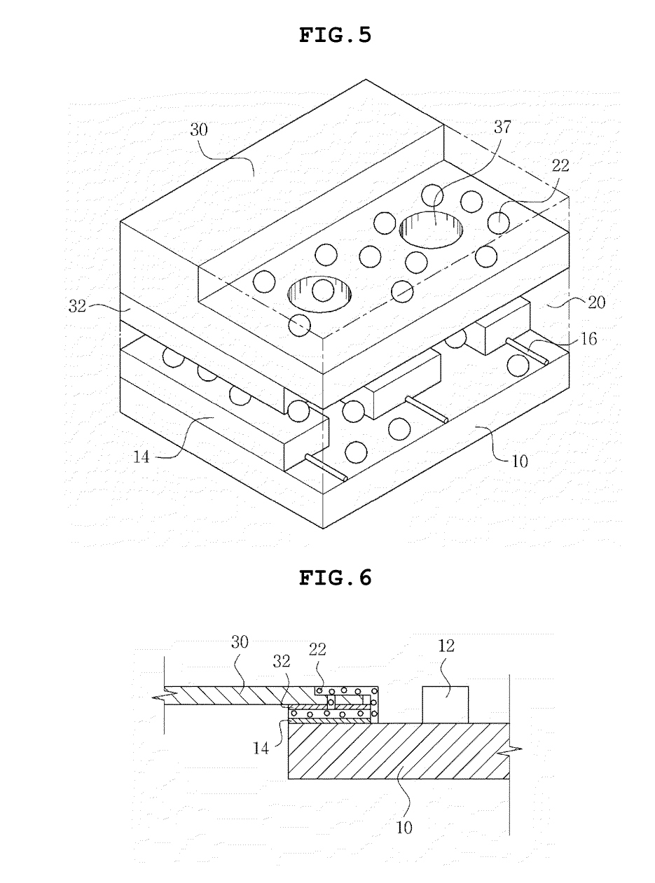

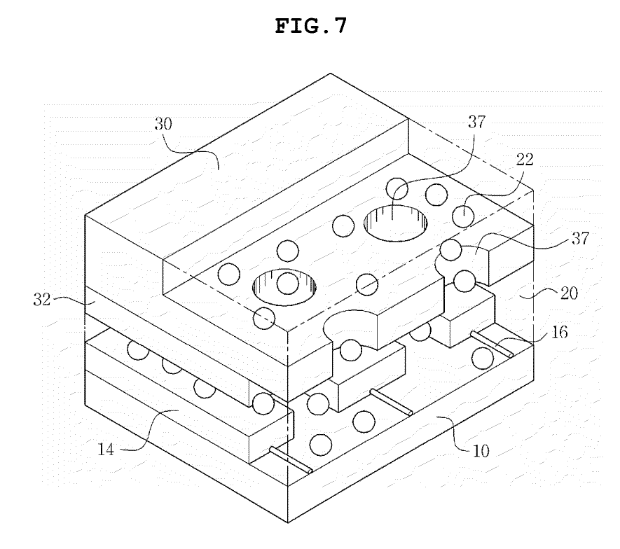

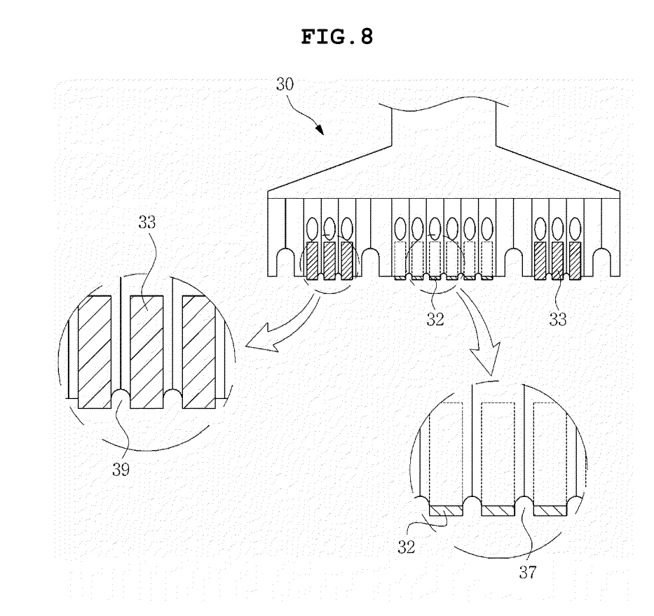

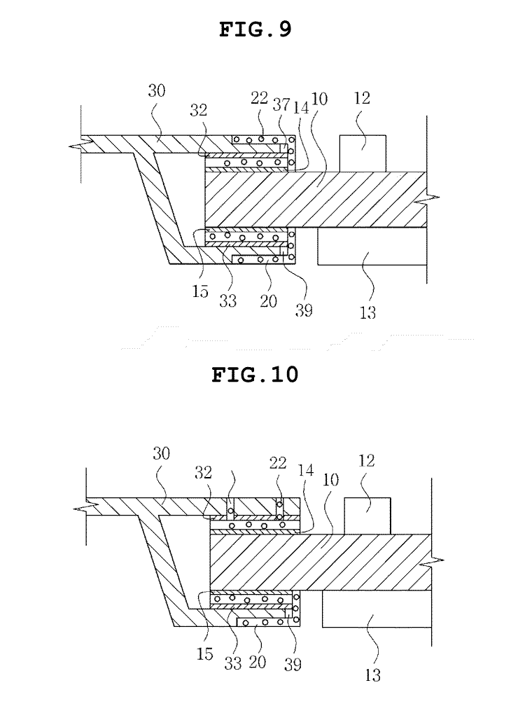

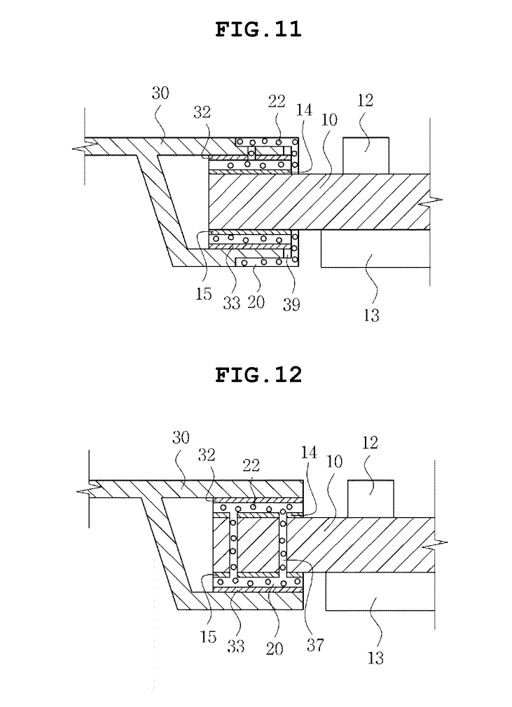

FIG. 1 is a cross-sectional view of assembly between a touch sensor and a flexible cable according to a first preferred embodiment of the present invention; FIG. 2 is a view showing a moving state of conductive balls of FIG. 1; FIG. 3 is a partial perspective view of FIG. 1; FIG. 4 is a view showing a first modified example for assembly between the touch sensor and the flexible cable according to the first preferred embodiment of the present invention; FIG. 5 is a partial perspective view of FIG. 4; FIG. 6 is a view showing a second modified example for assembly between the touch sensor and the flexible cable according to the first preferred embodiment of the present invention; FIG. 7 is a partial perspective view of FIG. 6; FIG. 8 is a front view of a flexible cable according to a second preferred embodiment of the present invention; FIG. 9 is a cross-sectional view of assembly between a touch sensor and a flexible cable according to the second preferred embodiment of the present invention; FIG. 10 is a view showing a third modified example for assembly between the touch sensor and the flexible cable according to the second preferred embodiment of the present invention; FIG. 11 is a view showing a fourth modified example for assembly between the touch sensor and the flexible cable according to the second preferred embodiment of the present invention; and FIG. 12 is a view showing a fifth modified example for assembly between the touch sensor and the flexible cable according to the second preferred embodiment of the present invention.

A term ‘touch’ used throughout the present specification should be widely interpreted so as to mean that an input unit becomes significantly close to the contact accommodating surface as well as mean that the input unit directly contacts the contact accommodating surface.

A touch sensor module according to the first preferred embodiment of the present invention is configured to include a base substrate having a plurality of electrode pads formed on one surface thereof; a flexible cable including terminal parts formed so as to correspond to the plurality of electrode pads and electrically connected to the plurality of electrode pads to transfer a signal and including penetration parts disposed between the terminal parts; and a conductive layer including conductive balls disposed between the electrode pads and the terminal parts and electrically connecting the electrode pads and the terminal parts to each other.

The touch sensor module 1 according to the first preferred embodiment of the present invention is to improve reliability of an electrical operation at the time of being touched by improving adhesion between the electrode pad 14 and the terminal part 32. In addition, reliability of an operation of the touch sensor module 1 against external impact is secured, such that convenience of a user may be secured and the touch sensor module 1 may be variously applied.

The base substrate 10 has a predetermined strength or more and is made of a transparent material. The base substrate 10 is not particularly limited, but may be made of polyethylene terephthalate (PET), polycarbonate (PC), poly methyl methacrylate (PMMA), polyethylene naphthalate (PEN), polyethersulfone (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), glass, tempered glass, or the like. In addition, since transparent electrodes may be formed on one surface of the base substrate 10, a surface treatment layer may be formed on one surface of the base substrate 10 by performing high frequency treatment, primer treatment, or the like, in order to improve adhesion between the base substrate 10 and the transparent electrodes.

An electrode pattern 12 serves to generate a signal at the time of the touch of the user, thereby allowing a controller to recognize a touch coordinate. The electrode pattern 12 may be formed by a plating process or a depositing process using a sputter. The electrode pattern 12 may be made of a metal formed by exposing/developing a silver salt emulsion layer. More specifically, it is obvious to those skilled in the art that the electrode pattern 12 may be made of various kinds of metals that have conductivity and are capable of forming mesh patterns. The electrode pattern 12 may be formed in all shapes known in the art, such as a diamond shape, a rectangular shape, a triangular shape, a circular shape, or the like.

Referring to FIGS. 1 and 2, the electrode pattern 12 may be formed in a bar shape. A plurality of electrode patterns 12 formed in the bar shape are electrically insulated from each other. The electrode pattern 12 may be formed of a conductive pattern and have a mesh shape. In the case in which the electrode patterns 12 are formed in the bar shape, they should be electrically insulated from each other. Since the electrode patterns 12 are connected to the electrode wirings 16, a coordinate value of a point at which a touch is performed is calculated, thereby making it possible to drive a device including a touch to sensor.

The electrode patterns 12 having the bar shape are formed in one direction on the base substrate 10 and are formed in a direction perpendicular to one direction on a separate base substrate 10, such that the touch sensor according to the first preferred embodiment of the present invention may be driven as a mutual type touch sensor coupling the two base substrates 10 to each other. Alternatively, patterns made of a bridge, which is an insulating material, and having a diamond shape are arranged on one surface of the base substrate 10 so as to be perpendicular to each other to form the electrode patterns 12 on a single base substrate 10, thereby making it possible to implement the touch sensor module 1.

The electrode wiring 16 is electrically connected to the electrode pattern 12 described above through the flexible cable 30. The electrode wiring 16 may be formed on the base substrate 10 by various printing methods such as a silk screen method, a gravure printing method, an inkjet printing method, or the like. As a material of the electrode wiring 16, copper (Cu), aluminum (Al), gold (Au), silver (Ag), titanium (Ti), palladium (Pd), or chromium (Cr) may be used. Particularly, silver (Ag) paste or organic silver having excellent electrical conductivity may be used as a material of the electrode wiring 16. However, the electrode wiring are not limited to being made of the above-mentioned material, but may be made of a conductive polymer, carbon black (including CNT), a metal oxide such as ITO, or a low resistance metal material such metals, or the like.

In FIG. 1, the electrode wiring 16 is connected only to one end of the electrode pattern 12 according to a scheme of the touch sensor module 1, which is only an example. That is, the electrode wiring 16 may also be connected to both ends of the electrode pattern 12. The electrode wiring 16 has the electrode pad 14 disposed at a distal end portion thereof, wherein the electrode pad 14 is electrically connected to the flexible cable 30. In other words, the electrode pad 14 is formed at one portion of the electrode wiring 16 and is electrically connected to the flexible cable 30.

Referring to FIG. 2, the electrode pad 14 is connected to the electrode wiring 16 and is formed on the base substrate 10. The electrode pad 14 is formed so as not to invade the flexible cable 30 and an active region of the base substrate 10, that is, a region in which a touch of the user is recognized. The electrode pad 14 is positioned at a distal end portion of one side of the base substrate 10 and is connected to the electrode wiring 16. The electrode pad 14 contacts the conductive layer 20 to allow electricity to be conducted to the flexible cable. The electrode pad is coupled to the conductive layer 20 by pressing the flexible cable 30. In this case, the electrode pad 14 is coupled to the conductive layer 20 in a direction in which the base substrate 10 is stacked. The electrode pad 14 has a contact surface contacting a conductive ball 22 of the conductive layer 20. The contact surface has a diameter larger than that of the conductive ball 22.

A plurality of electrode pads 14 are disposed at a distal end portion of one side of the base substrate 10. Here, the electrode pads 14 are formed to be spaced apart from each other by a predetermined distance so that electrical interference between adjacent electrode pads is not generated.

Referring to FIGS. 2 and 3, the conductive layer 20 contacts the electrode pad 14 and is electrically connected to the electrode pad 14. In the case in which the conductive layer 20 is pressed to thereby be coupled or adhered, an inner portion of the conductive layer 20 is provided with the conductive balls 22 having conductivity. The conductive balls 22 conduct electricity in one direction while being pressed to thereby be bonded in a process of coupling the electrode pad 14 and the terminal part 32 (See FIG. 2). The conductive layer 20 has a lower end surface connected to the electrode pad 14 and an upper end surface coupled and adhered to the terminal part 32. That is, the conductive ball 22 disposed in the conductive layer 20 has one surface adhered to the electrode pad 14 and the other surface adhered to the terminal part 32. This is not to limit a form in which the conductive layer 20 is adhered to the electrode pad 14 and the terminal part 32.

It is preferable that the conductive layer 20 is formed of an anisotropic conductive film (ACF). In some cases, the conductive layer 20 may be made of a conductive material such as an anisotropic conductive adhesive (ACA), or the like.

Some of the conductive balls 22 move along an inner portion of a penetration part 37 that is formed in the flexible cable 30 and is to be described below. Here, some of the conductive balls are disposed in the penetration part 37 to decrease shaking of the flexible cable 30 and the base substrate 10 with respect to external impact, thereby making it possible to secure electrical reliability. In addition, the conductive balls 22 except for some conductive balls 22 contacting the terminal part 32 and the electrode pad 14 move to the penetration part 37 to increase adhesion (See FIG. 2).

The flexible cable 30 includes the terminal parts 32 contacting the conductive layer 20. The flexible cable 30 is electrically connected to the electrode pad 14 to electrically connect the electrode pattern 12 and a controlling unit (not shown) to each other.

The terminal part 32 contacts the conductive balls 22 to thereby be electrically connected to the conductive balls 22. The terminal parts 32 are formed at positions corresponding to those of the plurality of electrode pads 14. As a material of the terminal part 32, copper (Cu), aluminum (Al), gold (Au), silver (Ag), titanium (Ti), palladium (Pd), chromium (Cr), or the like, may be used.

The terminal parts 32 have the penetration part 37 formed therebetween. The penetration part 37 increases coupling force between the terminal part 32 and the electrode pad 14. It is preferable that the penetration part 37 is formed at a distal end portion of the flexible cable in order to facilitate movement of the conductive balls (See FIG. 1). Here, the penetration part 37 is formed in a shape such as a semi-circular shape, a polygonal shape, a rectangular shape, or the like, and has a diameter larger than that of the conductive ball 22 (See FIGS. 2 and 3). This is to form the penetration part 37 so that conductive ball 22 is disposed in the penetration part 37, thereby increasing coupling force between the flexible cable 30 and the base substrate 10 with respect to external impact. In addition, the penetration part 37 is formed at the distal end of the flexible cable, thereby making it possible to easily couple or decouple the flexible cable to or from the base substrate.

The penetration part 37 is pressed when the electrode pad 14 and the terminal part 32 are coupled to each other, such that the conductive balls 22 move to the other side of the terminal 32 (See FIGS. 2 and 3). The penetration part serves as a rivet coupling structure connecting two different layers to each other, such that coupling force and adhesion are significantly improved. Further, some of the conductive balls 22 move to the other side of the terminal part 32 to serve to press the terminal part 32 at an upper end portion of the terminal part 32. This prevents separation of a bonding surface of the conductive ball 22 due to permeation of moisture, or the like, between bonding parts of the flexible cable 30 at the time of a reliability test, thereby making it possible to improve reliability of electrical characteristics.

The flexible cable 30 may also have a catching jaw formed in order to allow the conductive balls 22 not to be out of a predetermined range. It is preferable that the flexible cable 30 further includes an insulating plate formed in order to prevent exposure of the conductive layer 20 to the outside.

According to a first modified example for assembly between the touch sensor and the flexible cable, as shown in FIGS. 4 and 5, the penetration part 37 may be formed in a groove form or as a penetration groove between the terminal parts 32. At least one penetration part 37 may be formed along an outer peripheral surface of the terminal part 32. The penetration part 37 has the conductive balls 22 disposed therein.

In addition, according to a second modified example for assembly between the touch sensor and the flexible cable, as shown in FIGS. 6 and 7, the penetration parts 37 may be formed at both of a distal end of the flexible cable 30 and the center. This is not to limit forms and positions of the penetration parts 37.

The penetration parts 37 are formed in order to improve coupling force and adhesion. In addition, in order to dispose a plurality of penetration parts, it is preferable to consider electrical interference and rigidity of the flexible cable 30.

Hereinafter, a touch sensor module according to a second preferred embodiment of to the present invention will be described with reference to FIGS. 8 and 9. Particularly, a description of the same components as those of the touch sensor module according to the first preferred embodiment of the present invention will be omitted, and a coupling structure between a base substrate 10 and a flexible cable 30 according to the second preferred embodiment of the present invention will be described in detail,. A description of a structure and a material of a base substrate 10, an electrode pattern 12, an electrode wiring 16, an electrode pad 14, a conductive layer 20, and a terminal part 32 that are the same as those of the touch sensor module according to the first preferred embodiment of the present invention will be omitted.

In the touch sensor module according to the second preferred embodiment of the present invention, electrode patterns 12 and 13, which serve to generate a signal at the time of touch by an input unit to allow a controller to recognize a touch coordinate, are formed on the base substrate 10. The electrode patterns 12 and 13 having a bar shape are formed in one direction on the base substrate 10 and are formed in a direction perpendicular to one direction on a separate base substrate 10, such that the touch sensor module according to the second preferred embodiment of the present invention may be driven as a mutual type touch sensor coupling the two base substrates 10 to each other.

The electrode pattern formed in an X axis direction on one surface of the base substrate 10 will be referred to as a first electrode pattern 12, and the electrode pattern formed in a Y axis direction on the other surface of the base substrate 10 will be referred to as a second electrode pattern 13 (See FIG. 9).

In addition, the electrode pad formed at a distal end portion of the first electrode pattern 12 will be referred to as a first electrode pad 14, and the electrode pad formed at a distal end portion of the second electrode pattern 13 will be referred to as a second electrode pad 15. The terminal part formed at a position corresponding to that of the first electrode pad 14 will be referred to as a first terminal part 32, and the terminal part formed at a position corresponding to that of the second electrode pad 15 will be referred to as a second terminal part 33.

The first electrode pad 14 and the second electrode pad 15 are connected to the electrode wirings and are formed on one surface and the other surface of the base substrate 10, respectively. The first and second electrode pads 14 and 15 are formed so as not to invade an active region of the base substrate 10, that is, a region in which a touch of the user is recognized. The first and second electrode pads 14 and 15 are positioned at a distal end portion of one side of the base substrate 10, respectively, and are connected to the electrode wirings 16. Each of the first and second electrode pads 14 and 15 contacts the conductive layer 20 to allow electricity to be conducted to the flexible cable 30 (See FIG. 9).

The first and second electrode pads 14 and 15 are formed at different positions. This is to electrically connect the first and second electrode pads 14 and 15 to the first and second terminal parts 32 and 33 of the flexible cable 30, respectively (See FIGS. 8 and 9). The first and second electrode pads 14 and 15 contact the conductive layer 20 and are pressed to thereby be coupled to the flexible cable 30.

The conductive layer 20 contacts each of the first and second electrode pads 14 and 15 and is electrically connected to each of the first and second electrode pads 14 and 15. The conductive balls 22 disposed in the conductive layer 20 has one surface adhered to each of the first and second electrode pads 14 and 15 and the other surface adhered to each of the first and second terminal parts 32 and 33 (See FIG. 8).

It is preferable that the conductive layer 20 is formed of an anisotropic conductive film (ACF). In some cases, the conductive layer 20 may be made of a conductive material such as an anisotropic conductive adhesive (ACA), or the like. In the case in which the conductive layer 20 is pressed to thereby be coupled or adhered, an inner portion of the conductive layer 20 is provided with the conductive balls 22 having conductivity.

The conductive ball 22 is pressed in a process in which the first electrode pad 14 formed on one surface of the base substrate 10 is coupled to the first terminal part 32, thereby allowing electricity to be conducted (See FIG. 2). The conductive ball 22 electrically connects the second electrode pad 15 formed on the other surface of the base substrate 10 and the second terminal part 33 to each other.

Some of the conductive balls 22 move along inner portions of first and second penetration parts 37 and 39 that are formed in the flexible cable 30 and are to be described below (See FIG. 9). Here, some of the conductive balls 22 are disposed in the first and second penetration parts 37 and 39 to decrease shaking of the flexible cable 30 and the base substrate 10 with respect to external impact, thereby making it possible to secure electrical reliability.

The flexible cable 30 includes the first and second terminal parts 32 and 33 contacting the conductive layer 20. The flexible cable 30 is electrically connected to the first electrode pad 14 to electrically connect the first electrode pattern 12 and a controlling unit (not shown) to each other. In addition, the flexible cable 30 is electrically connected to the second electrode pad 15 to electrically connect the second electrode pattern 13 and the controlling unit (not shown) to each other.

The first terminal part 32 contacts the conductive balls 22 to thereby be electrically connected to the conductive balls 22. The first terminal part 32 is electrically connected to the first electrode pattern 12. The first terminal parts 32 are formed at positions corresponding to those of a plurality of first electrode pads 14 (See FIGS. 8 and 9). As a material of the first terminal part 32, copper (Cu), aluminum (Al), gold (Au), silver (Ag), titanium (Ti), palladium (Pd), chromium (Cr), or the like, may be used.

The first terminal parts 32 have the first penetration part 37 disposed therebetween. The first penetration part 37 increases coupling force between the first terminal part 32 and the first electrode pad 14. It is preferable that the first penetration part 37 is formed at a distal end portion of the flexible cable 30 in order to facilitate movement of the conductive balls 22. Here, the first penetration part 37 is formed in a shape such as a semi-circular shape, a polygonal shape, a rectangular shape, or the like, and has a diameter larger than that of the conductive ball 22. This is to form the first penetration part 37 so that conductive ball to 22 is disposed in the first penetration part 37, thereby increasing coupling force between the flexible cable 30 and the base substrate 10 with respect to external impact. In addition, the first penetration part 37 is formed at a distal end of the flexible cable 30, thereby making it possible to easily couple or decouple the flexible cable 30 to or from the base substrate 10.

In the first penetration part 37, the conductive balls 22 are pressed to thereby move to the other side of the first terminal part 32. The first penetration part serves as a rivet coupling structure connecting two different layers to each other, such that coupling force and adhesion are significantly improved. Further, this prevents separation of a bonding surface of the conductive ball 22 due to permeation of moisture, or the like, between bonding parts of the flexible cable 30 at the time of reliability test, thereby making it possible to improve reliability of electrical characteristics.

The flexible cable 30 may also have a catching jaw formed in order to allow the conductive balls 22 not to be out of a predetermined range. It is preferable that the flexible cable 30 further includes an insulating plate 34 formed in order to prevent exposure of the conductive layer 20 to the outside.

Referring to FIG. 9, the second terminal part 33 is formed on an opposite surface to a surface on which the first terminal part 32 is formed. The second terminal parts 33 are formed at both sides of the first terminal part 32. This is to prevent a phenomenon that the flexible cable 30 is pressed and inclined when the second terminal part 33 is coupled to the conductive layer 20. In addition, this is to increase coupling force between the flexible cable 30 and the base substrate 10. The second terminal part 33 is electrically connected to the second electrode pad 15 to electrically connect the second electrode pattern 13 and the controlling unit (not shown) to each other.

The second terminal parts 33 have the second penetration part 39 disposed therebetween. The second penetration part 39 increases coupling force between the second terminal part 33 and the second electrode pad 15. It is preferable that the second penetration part 39 is formed at a distal end portion of the flexible cable 30 in order to facilitate movement of the conductive balls 22.

According to a third modified example for assembly between the touch sensor and the flexible cable, the first penetration part 37 may be formed as a groove in a portion of the base substrate 10 or be formed to penetrate through the base substrate 10. The first penetration part 37 is formed in a range in which electrical interference between the first electrode pads 14 is not generated. The first penetration part 37 may also be formed in a groove form or as a penetration groove between the first electrode pads 14 of the base substrate. A plurality of first penetration parts 37 may also be formed along an outer peripheral surface of the first electrode pad 14.

The second penetration part 39 is disposed at a distal end of the flexible cable 30. The second penetration part 39 is formed in a range in which electrical interference between the second electrode pads 15 is not generated. Some of the conductive balls 22 are inserted into the first and second penetration parts 37 and 39. Here, the first and second penetration parts 37 and 39 are disposed in consideration of rigidity of the base substrate 10 and electrical interference. Positions of the first and second penetration parts 37 and 39 may be changed with each other.

According to a fourth modified example for assembly between the touch sensor and the flexible cable, the first penetration part 37 is formed at a distal end portion of the flexible cable 30 in order to facilitate movement of the conductive balls 22 and is formed to penetrate through the base substrate in a range in which electrical interference between the first electrode pads 14 is not generated.

The second penetration part 39 is disposed at a distal end of the flexible cable 30. The second penetration part 39 is formed in a range in which electrical interference between the second electrode pads 15 is not generated. Some of the conductive balls 22 are inserted into the first and second penetration parts 37 and 39. Here, the first and second penetration parts 37 and 39 are disposed in consideration of rigidity of the base substrate and electrical interference. Positions of the first and second penetration parts 37 and 39 may be changed to with each other.

According to a fifth modified example for assembly between the touch sensor and the flexible cable 30, the penetration part 37 is formed at a distal end of the base substrate in order to facilitate movement of the conductive balls 22 or is formed as a penetration hole in a range in which electrical interference between the first electrode pads 14 is not generated. When the flexible cable 30 is pressed, the conductive balls 22 move into the base substrate 10, such that adhesion is improved.

According to the preferred embodiment of the present invention, the conductive balls are formed in the penetration part to increase coupling force and adhesion between the electrode pad and the terminal part, thereby making it possible to improve reliability. In addition, the conductive balls are formed in the penetration part, thereby making it possible to improve reliability for coupling force of the conductive balls depending on a storing state of the conductive layer and a deviation.

Further, the conductive balls are formed in the penetration part, thereby making it possible to prevent a delamination phenomenon generated in the conductive balls at the time of contact between the electrode pad and the terminal part.

Furthermore, the conductive balls are formed in the penetration part, thereby making it possible to prevent an electrical short-circuit due to permeation of moisture into flexible cable.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch sensor module comprising:
a base substrate having a plurality of electrode pads formed on one surface thereof;
a flexible cable including terminal parts formed so as to correspond to the plurality of electrode pads and electrically connected to the plurality of electrode pads to transfer a signal to the outside and including penetration parts disposed between the terminal parts; and
a conductive layer including conductive balls disposed between the electrode pads and the terminal parts and electrically connecting the electrode pads and the terminal parts to each other.

2. The touch sensor module as set forth in claim 1, wherein the penetration part has a diameter larger than those of the conductive balls so that the conductive balls move to an opposite surface of the terminal part.

3. The touch sensor module as set forth in claim 2, wherein a plurality of penetration parts are formed along an outer peripheral surface of the terminal part.

4. The touch sensor module as set forth in claim 1, wherein the penetration part is formed in a semi-hole form at a distal end of the flexible cable so that the conductive balls move to an opposite surface of the terminal part to increase coupling force.

5. The touch sensor module as set forth in claim 1, wherein the conductive layer is made of an anisotropic conductive film (ACF) or an anisotropic conductive adhesive (ACA).

6. A touch sensor module comprising:
a base substrate having a plurality of electrode pads formed on one surface thereof and penetration parts formed between the electrode pads;
a flexible cable including terminal parts formed so as to correspond to the plurality of electrode pads and electrically connected to the plurality of electrode pads to transfer a signal; and
a conductive layer including conductive balls disposed between the electrode pads and the terminal parts and electrically connecting the electrode pads and the terminal parts to each other.

7. The touch sensor module as set forth in claim 6, wherein the penetration part is formed so that the conductive balls move to an opposite surface of the electrode pad or are positioned in the base substrate.

8. The touch sensor module as set forth in claim 7, wherein a plurality of penetration parts are formed along an outer peripheral surface of the electrode pad.

9. The touch sensor module as set forth in claim 6, wherein the penetration part is formed at a distal end of the base substrate so that the conductive balls move to an opposite surface of the electrode pad to increase coupling force.

10. The touch sensor module as set forth in claim 6, wherein the conductive layer is made of an ACF or an ACA.

11. A touch sensor module comprising:
a base substrate having a plurality of electrode pads formed on one surface thereof and a first penetration part formed between the electrode pads;
a flexible cable including terminal parts formed so as to correspond to the plurality of electrode pads and electrically connected to the plurality of electrode pads to transfer a signal and a second penetration part disposed between the terminal parts; and
a conductive layer including conductive balls disposed between the electrode pads and the terminal parts and electrically connecting the electrode pads and the terminal parts to each other.

12. The touch sensor module as set forth in claim 11, wherein the first penetration part has a diameter larger than those of the conductive balls so that the conductive balls are pressed, such that they move to an opposite surface of the electrode pad or some of the conductive balls are inserted into the first penetration part, and
the second penetration part has a diameter larger than those of the conductive balls so that the conductive balls are pressed, such that they move to an opposite surface of the terminal part or some of the conductive balls are inserted into the second penetration part.

13. The touch sensor module as set forth in claim 11, wherein the first penetration part is formed at a distal end of the base substrate so that the conductive balls move to an opposite surface of the electrode pad to increase coupling force.

14. The touch sensor module as set forth in claim 11, wherein the second penetration part is formed at a distal end of the base substrate so that the conductive balls move to an opposite surface of the terminal part to increase coupling force.

15. The touch sensor module as set forth in claim 11, wherein the first and second penetration parts are formed at distal ends of the base substrate and the flexible cable, respectively, so that the conductive balls move to an opposite surface of the electrode pad and the terminal part to increase coupling force.

16. The touch sensor module as set forth in claim 11, wherein the conductive layer is made of an ACF or an ACA.
